(19) United States
(12) Patent Application Publication
(10) Pub. No.: US 2016/0352422 A1
(43) Pub. Date: Dec. 1, 2016

(54) MULTI-FUNCTIONAL SMART LED SYSTEMS WITH VISIBLE LIGHT COMMUNICATION AND IP-BASED RADIOFREQUENCY CONNECTIVITY

(71) Applicant: THE HONG KONG UNIVERSITY OF SCIENCE AND TECHNOLOGY, Hong Kong (CN)

(72) Inventors: Chik Patrick YUE, Hong Kong (CN); Liang WU, Hong Kong (CN)

(73) Assignee: THE HONG KONG UNIVERSITY OF SCIENCE AND TECHNOLOGY, Hong Kong (CN)

(21) Appl. No.: 15/114,673

(22) PCT Filed: Nov. 5, 2014
(86) PCT No.: PCT/CN2014/000971

§ 371 Date: Jul. 27, 2016

Related U.S. Application Data
(60) Provisional application No. 61/967,423, filed on Mar. 18, 2014.

(51) Int. Cl. H04B 10/116; H04B 10/40; H04B 10/50; H04B 1/38; H04W 4/04

(52) U.S. Cl. CPC H04B 10/116; H04B 1/38; H04W 4/043; H04B 10/502; H04B 10/40; H04W 84/12

(57) ABSTRACT

A communications device includes: a light-emitting diode (LED) or LED array; an internet protocol (IP)-based radiofrequency (RF) wireless unit, configured to transmit and receive data over a RF wireless communications network; a visible light communication (VLC) unit, configured to drive the LED or LED array and modulate light generated by the LED or LED array with data; a control unit, connected to the IP-based RF wireless unit and the VLC unit, configured to facilitate communications between the VLC unit and IP-based RF wireless unit.

### CROSS-REFERENCE TO RELATED APPLICATIONS

This patent application claims the benefit of U.S. Provisional Patent Application No. 61/967,423, filed Mar. 18, 2014, which is incorporated by reference.

### FIELD

Embodiments of the invention relate to a multi-functional smart LED system architecture, and in particular, to a smart LED system having several integrated capabilities, including illumination, Internet Protocol (IP)-based radiofrequency (RF) connectivity and visible light communication (VLC).

### BACKGROUND

Light-emitting diodes (LEDs) represent an eco-friendly illumination technology which features high luminous efficiency, long lift time and high reliability. LEDs, which are growing in popularity due to increasing performance and decreasing costs, are often used for lighting, display and signage applications.

In addition, the high response speed of LEDs makes them suitable for electronic modulation, allowing them to be used in visible light communication (VLC) applications. The modulation frequency for LEDs can be set high enough to achieve meaningful data rates and to greatly exceed the flicker fusion threshold of human beings, such that the LEDs' basic illumination function is not affected by the modulation. Compared with traditional wireless radiofrequency (RF) communications, VLC is advantageous in terms of higher security, no RF radiation, wide available spectrum and transceiver simplicity. For example, for downlink communications, VLC is able to reach data rates at the Gb/s level, and, for indoor positioning, VLC is able to achieve accuracy at the sub-meter level.

However, there are also drawbacks to conventional VLC systems. For example, conventional VLC systems lack an effective way to integrate a backhaul system for data delivery to the source of the VLC downlink. For VLC to be used in downlink communications, the data to be transmitted over visible light needs to be delivered to the illumination fixture. Given that the LEDs are always connected to the power line, power line communication (PLC) has been recognized as a potential mechanism for providing a backhaul system. However, PLC devices are expensive and would significantly increase the costs associated with such a LED VLC system. Further, in terms of performance, PLC devices are sensitive to the noise from power grids, resulting in potential drops in data rate and communication interruptions. There is also a limit on the quantity of PLC devices allowed within one power grid, which is another obstacle to deployment of a LED VLC system using PLC technology for a backhaul.

Another drawback relating to VLC systems is that conventional VLC systems lack a mechanism for VLC receivers to request data or other services via an uplink connection.

### SUMMARY

Embodiments of the invention provide for a multi-functional, smart LED device for a variety of applications, including but not limited to solid-state lighting, display and signage applications. The LED device provides VLC capabilities integrated with IP-based RF wireless connectivity, and includes, for example, a VLC unit, an IP-based RF wireless unit, a control unit with a memory (e.g., a non-volatile memory), and a LED array.

With respect to the VLC capabilities, light from LEDs of the LED array is modulated at a high frequency such that any flickering associated therewith is imperceptible to the human eye. The modulated signal can thus be captured and decoded by nearby VLC receivers without any degradation to the LEDs' lighting functionality.

The IP-based RF wireless connectivity provides a data backhaul and/or uplink for the VLC-based communications, and further allows the VLC-based communications to be utilized as a bridge to extend RF signal coverage for an RF wireless communications network.

Thus, embodiments of the multi-functional, smart LED device discussed herein provide for VLC communications integrated with RF wireless connectivity, while at the same time providing for illumination for various applications (e.g., lighting, display, signage, etc.). Further, the synergy and meshed usage of LED-based VLC and IP-based RF wireless connectivity allows for additional advantages to be achieved, including but not limited to high power efficiency, high reliability and low costs (including overall system costs as well as installation costs).

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIGS. 1A-1B are schematic diagrams illustrating exemplary smart LED systems.

FIG. 2 is a block diagram illustrating components of an exemplary smart LED device.

FIGS. 3A-3B are block diagrams illustrating data pathways in various contexts for the exemplary smart LED device depicted in FIG. 2.

FIG. 4 is a block diagram illustrating components of another exemplary smart LED device.

FIGS. 5A-5C are block diagrams illustrating data pathways in various contexts for the exemplary smart LED device depicted in FIG. 4.

FIGS. 6-8 are flowcharts illustrating operations performed by exemplary smart LED devices.

### DETAILED DESCRIPTION

Embodiments of the invention provide for a multi-functional, smart LED device for a variety of applications, including but not limited to solid-state lighting, display and signage applications. The LED device provides VLC capabilities integrated with IP-based RF wireless connectivity, and includes, for example, a VLC unit, an IP-based RF wireless unit, a control unit with a memory (e.g., a non-volatile memory), and a LED array.

In an exemplary embodiment, information received via an IP-based RF wireless connectivity interface of the IP-based RF wireless unit is used to program, control and monitor the VLC unit (e.g., including setting the operating frequency of the VLC unit, setting the light intensity of the VLC unit, and determining/transmitting the operating status of VLC unit). Communications between the VLC unit of a device with the VLC of another device are used to extend signal coverage of the RF wireless communications network (i.e., allowing the devices to serve as VLC-based access points to the RF wireless communications network and/or allowing the devices to provide bridges via VLC links to extend coverage of the RF wireless communications network). Alternatively or additionally, the IP-based RF wireless unit may provide a backhaul for the VLC as well as an uplink connection for the VLC. This allows the IP-based RF wireless unit to serve as an RF-based access points to the VLC network and/or allows RF links to act as bridges that extends coverage of a VLC network. In addition, the IP-based RF wireless unit itself may serve as an RF access point to communicate with RF clients and/or communicate with other the IP-based RF wireless units to extent the RF signal coverage. Thus, it will be appreciated that by utilizing the multifunctional, smart LED devices according to embodiments of the invention, a hybrid VLC and IP-based RF system can be formed that utilizes the smart LED devices to provide VLC communication and extend an IP-based RF wireless communication network, as well as provide additional forms of access for both networks. The system may further include smart LED servers, which also provide illumination, bi-directional VLC, and IP-based RF wireless connectivity.

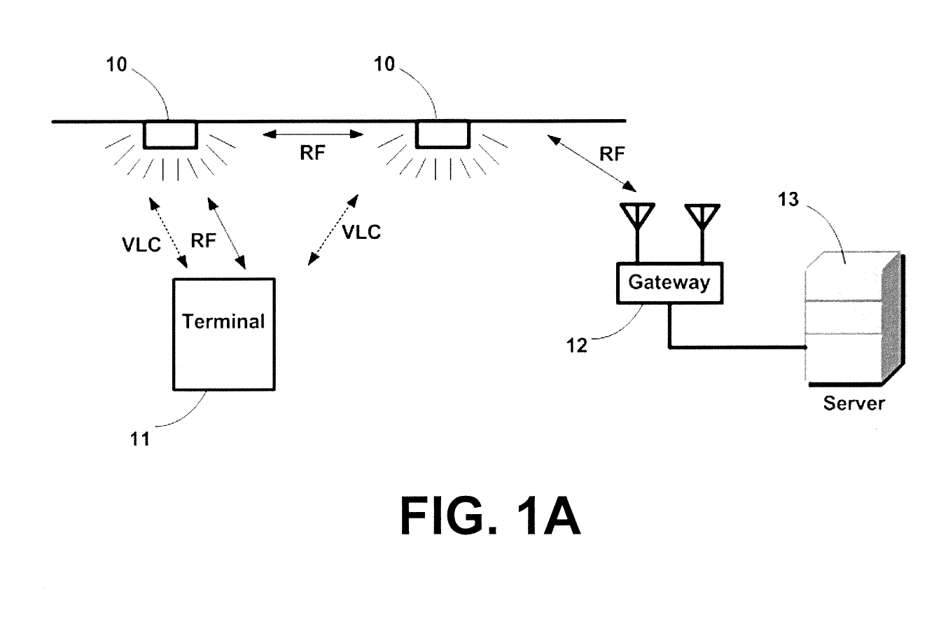

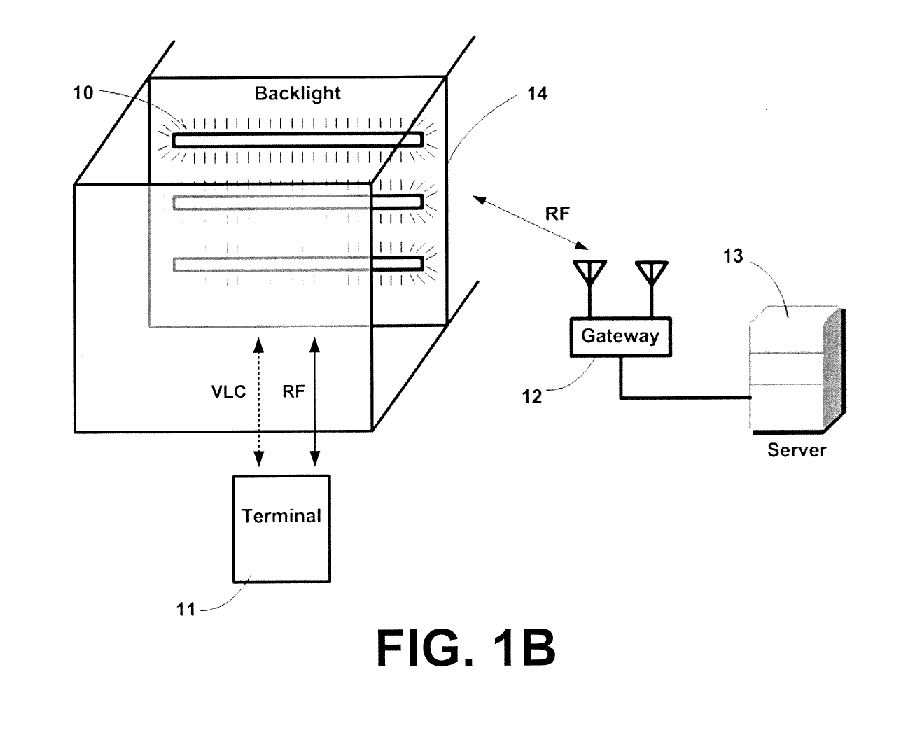

FIG. 1A is a diagram providing an exemplary illustration of the configuration of a multi-functional smart LED system, with smart LED devices 10 having integrated VLC and IP-based RF capabilities being used for lighting applications. A terminal 11 (for example, a computing device with VLC and IP-based RF communication capabilities) near one or more smart LED devices 10 can communicate with a server 13 through an RF gateway 12 via multiple different pathways, which may include, for example, VLC or IP-based RF communications between the terminal 11 and a smart LED device 10, as well as RF communications between smart LED devices 10 and RF communications between a smart LED device 10 and the RF gateway 12.

FIG. 1B is a diagram providing an exemplary illustration of the configuration of a multi-functional smart LED system, with smart LED devices 10 having integrated VLC and IP-based RF capabilities and being used for a display or signage application. In an exemplary display application, the illumination from multi-functional smart LED devices 10 is used as backlight 14 for a display panel such as LCD. In an exemplary signage application, the illumination from multi-functional smart LED devices 10 is used as backlight 14 for a sign such as an advertisement board. Similar to the discussion above with respect to FIG. 1A, a terminal 11 near the smart LED devices 10 can communicate with a server 13 through an RF gateway 12 via multiple different pathways, which may include, for example, VLC or IP-based RF communications between the terminal 11 and a smart LED device 10, as well as RF communications between a smart LED device 10 and the RF gateway 12.

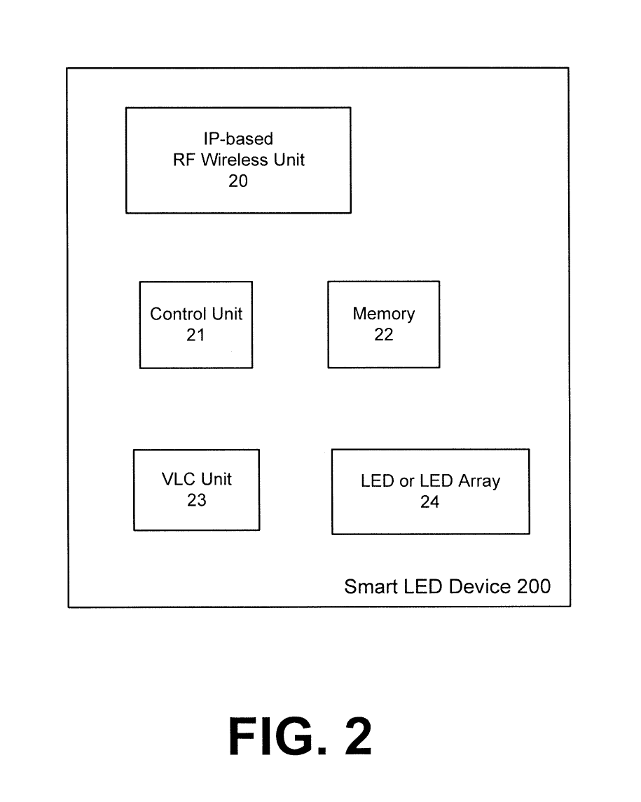

FIG. 2 is a block diagram showing components of a multi-functional smart LED device 200 in an exemplary embodiment. The smart LED device 200 includes an IP-based RF wireless unit 20 for providing IP-based wireless connectivity functions, a LED or LED array 24 with a VLC unit 23 for utilizing the LED or LED array 24 for VLC, and a control unit 21 for integrating RF-based communications carried out by the IP-based RF wireless unit 20 with VLC-based communications carried out by the VLC unit 23 with LED or LED array 24.

The IP-based RF wireless unit 20 includes, for example, a wireless transceiver (e.g., a WiFi-capable transceiver), and it is capable of receiving and transmitting signals at RF-level frequencies. Internet Protocol (IP) is the set of standards responsible for ensuring that data packets transmitted over the Internet are routed to their intended destinations. The VLC unit 23 includes, for example, a LED driver to power up the LEDs, a VLC modulator to switching the LEDs on/off corresponding to its input data (which may be implemented as or similar to the digital dimming port of a LED driver). The control unit 21 includes, for example, a processor (e.g., a microcontroller) to process commands and data communicated among the RF wireless unit 20, the VLC unit 23 and other devices, and to coordinate their operations. The memory 22, for example, a non-volatile memory (e.g., flash memory or EEPROM), is used to store program(s) and data for the control unit 21. Once the whole smart LED system is powered up, the control unit 21 reads the program and data in the memory 22. The LED or LED array 24 may be a single LED or arrangement of LEDs suitable for various applications, such as lighting, display and signage applications. Depending on the LED driver in the VLC unit 23, the LEDs may be connected in series or in parallel or both.

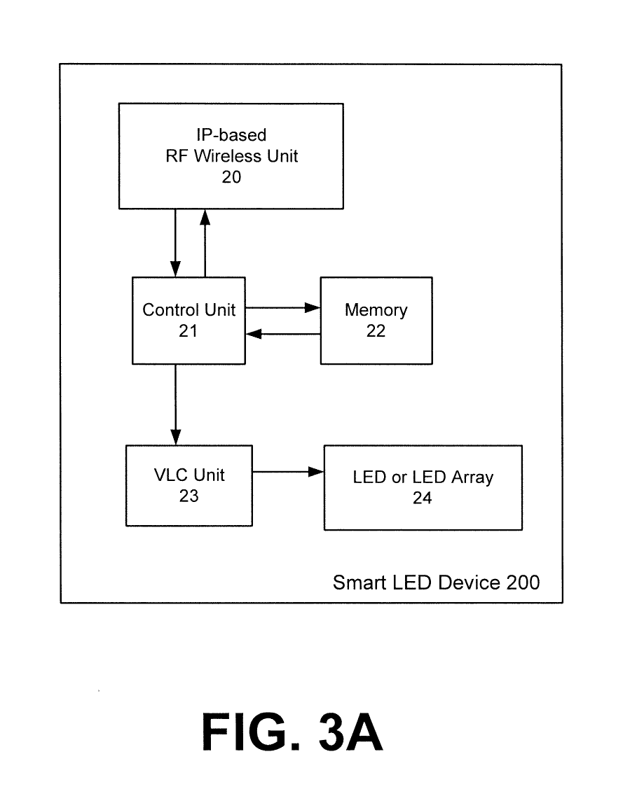

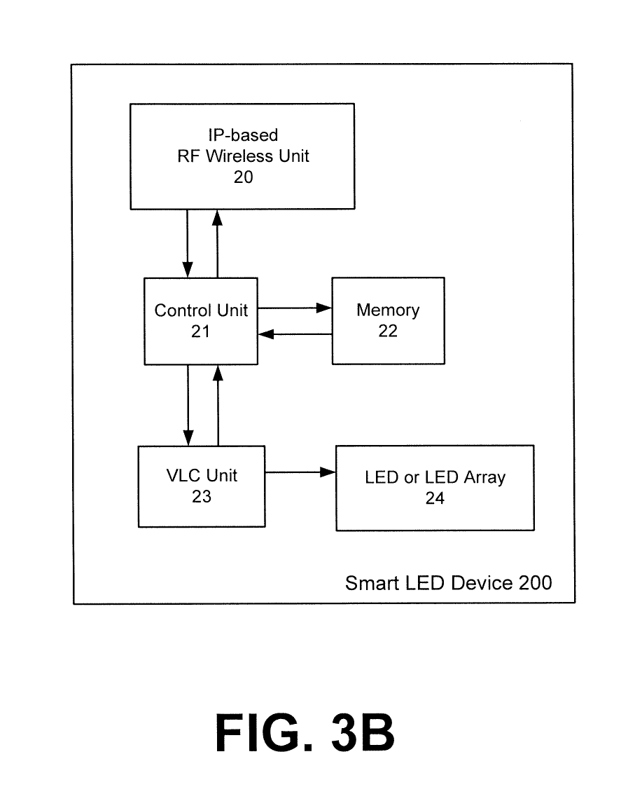

FIG. 3A is a block diagram illustrating communication pathways for the exemplary smart LED device depicted in FIG. 2 in a situation where the VLC functionality of the smart LED device is being used for information broadcasting or data transmission (e.g., including broadcasting address, position, and/or identification information). The control unit 21 controls the IP-based RF wireless unit 20 (e.g., to set it to be in transmit mode or in receive mode). The memory 22 stores instructions (e.g., processor-executable instructions, part of a program) for the control unit 21 to execute. The memory 22 may also be used to store data to be used in a VLC information broadcast or to be transmitted via VLC (e.g., the data for broadcast or transmission, as well as commands related thereto, may be received via the IP-based RF wireless unit 20, with the control unit 21 causing the data and/or commands to be stored at the memory 22). The control unit 21 further controls the VLC unit 23 (e.g., pursuant to a received command) to utilize the LED or LED array 24 for the VLC information broadcast or VLC data transmission (e.g., by instructing a LED driver of the VLC unit 23 to modulate light from the LED or LED array 24 with the data for broadcast or transmission from the memory 22).

It will be appreciated that the LED light is modulated to broadcast or transmit information without visibly affecting the illumination function performed by the LED or LED array 24. It will further be appreciated that the specific pathways described above and depicted in FIG. 3A are merely exemplary, and that other implementations of these pathways and smart LED device components are achievable without departing from the inventive principles (e.g., by setting up a direct connection between VLC unit 23 and memory 22 such that the VLC unit 23 directly obtains the data for broadcast; or by using a separate buffer for the data to be broadcast such that the data for broadcast does not need to be stored at memory 22). This also applies to other figures of the application that will be discussed further below, which are also merely exemplary and not intended to limit the scope of the invention to only the depicted pathways and configurations.

FIG. 3B is a block diagram illustrating communication pathways for the exemplary smart LED device depicted in FIG. 2 in a situation where the VLC functionality of the smart LED device is being used for bi-directional communication. The operation of the smart LED device 200 according to FIG. 3B is similar to FIG. 3A as discussed above, except that FIG. 3B further illustrates that information and/or commands may also be carried from the VLC unit 23 to the IP-based RF wireless unit 20 via the control unit 21. Such information and/or commands may be received via a VLC receiver of the VLC unit 23. Like in FIG. 3A, the control unit 21 buffers the data, performs reformatting as needed for the VLC unit 23 and the IP-based RF wireless unit 20 to interact, and sets the operation of the VLC unit 23 and the IP-based RF wireless unit 20 independently either in transmit mode or receive mode. FIG. 3B further depicts that the IP-based RF wireless unit 20 is able to act as an uplink backhaul for the VLC link established by the VLC unit 23 (in addition to being a downlink backhaul as depicted in both FIGS. 3A and 3B). In this example, the VLC unit 23 includes a LED driver, a VLC modulator and a VLC receiver.

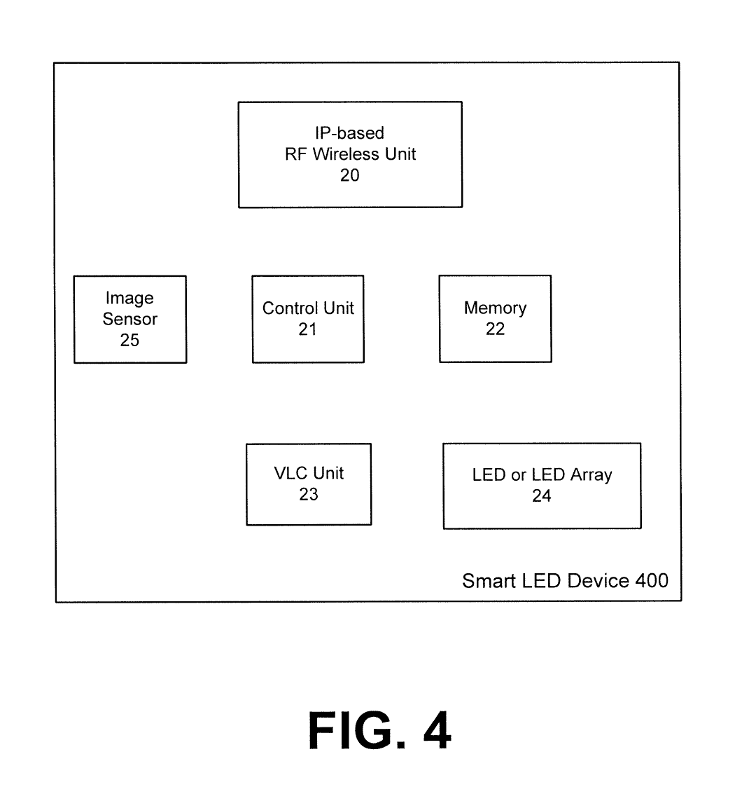

FIG. 4 is a block diagram showing components of a multi-functional smart LED device 400 in a further exemplary embodiment. The smart LED device 400 of FIG. 4 is similar to the smart LED device 200 of FIG. 2, except that it further includes an image sensor 25 (e.g., a CMOS image sensor). The image sensor 25 device may be, for example, a camera through which pictures or videos can be captured.

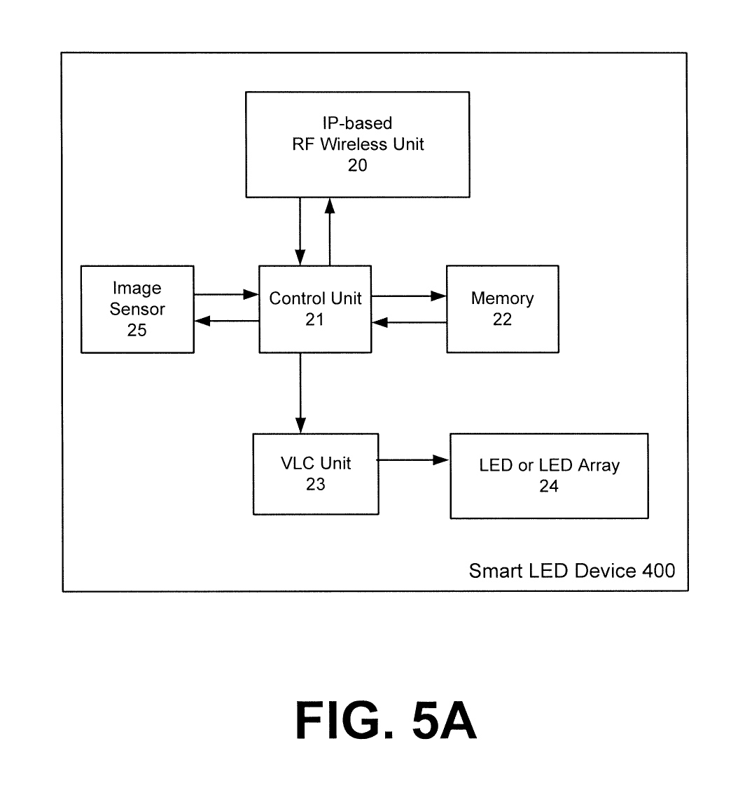

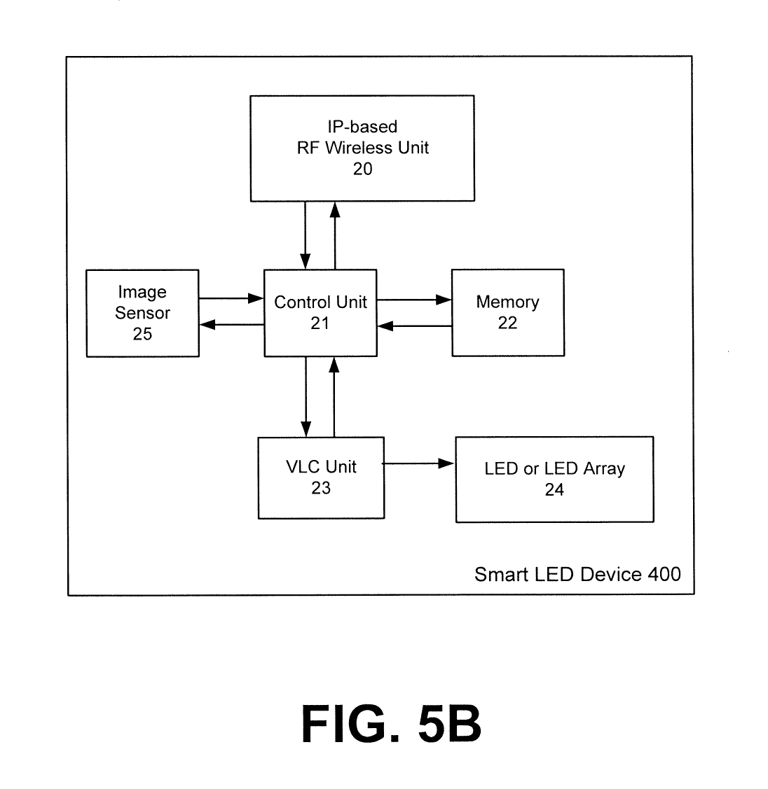

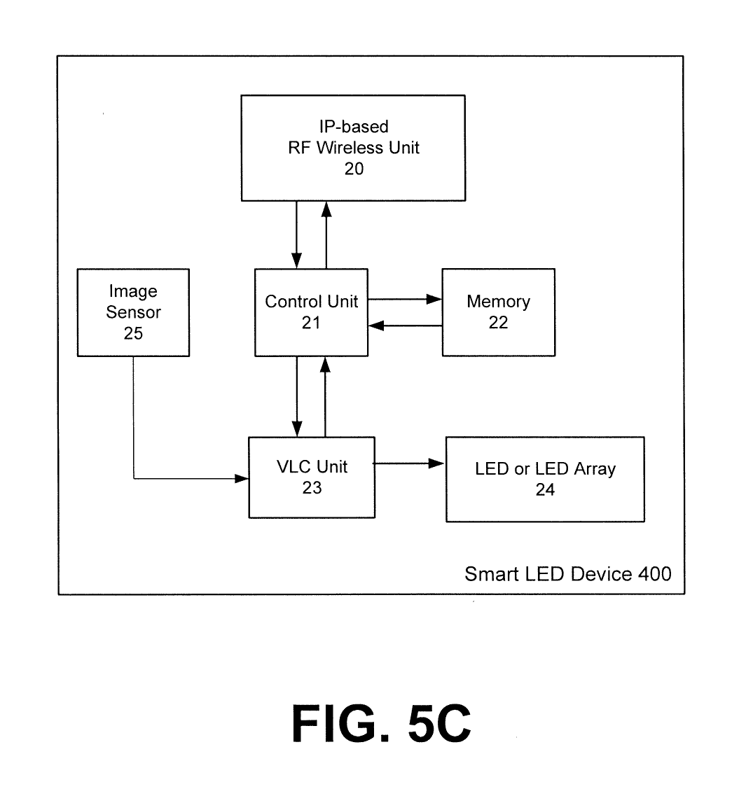

FIG. 5A is a block diagram illustrating communication pathways for the exemplary smart LED 400 depicted in FIG. 4 in a situation where the VLC functionality of the smart LED device is being used for information broadcasting or data transmission. The operation of the smart LED device 400 as illustrated in FIG. 5A is similar to the operation of smart LED device 200 as depicted in FIG. 3A and described above, except that smart LED device 400 further provides for image and/or video information captured by the image sensor 25 to be sent to a server via IP-based RF wireless unit 20, and for the control unit 21 to be able to control the image sensor 25.

FIG. 5B is a block diagram illustrating communication pathways for the exemplary smart LED device 400 depicted in FIG. 4 in a situation where the VLC functionality of the smart LED device is being used for bi-directional communication. The operation of the smart LED device 400 as illustrated in FIG. 5A is similar to the operation of smart LED device 200 as depicted in FIG. 3B and described above, except that smart LED device 400 further provides for image and/or video information captured by the image sensor 25 to be sent to a server via IP-based RF wireless unit 20, and for the control unit 21 to be able to control the image sensor 25.

FIG. 5C is a block diagram illustrating communications pathways for the exemplary smart LED device 400 depicted in FIG. 4 in another exemplary embodiment where the image sensor 25 is alternatively be connected to the VLC unit 23, such that images/data captured by the image sensor 25 is relayed to the control unit via the VLC unit 23.

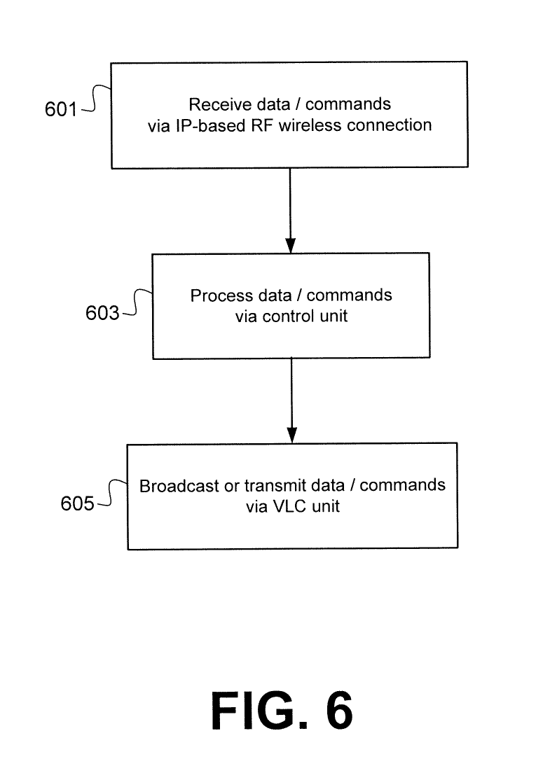

FIGS. 6-8 are exemplary flowcharts illustrating functions that the exemplary smart LED devices discussed above are capable of. FIG. 6 illustrates a process by which communications including data and/or commands received by the smart LED device via the IP-based RF wireless unit of the smart LED device (stage 601) are processed by the control unit (stage 603) and broadcasted or transmitted to other smart LED devices and/or networked devices via the VLC unit of the smart LED device (stage 605). Processing the data and/or commands via the control unit at stage 603 further includes determining the destination of the data and/or commands (e.g., whether a command is intended for execution by the VLC unit, the IP-based RF wireless unit, or for other devices), reformatting the data and/or commands as needed, and routing/transmitting the data and/or commands to the appropriate destination.

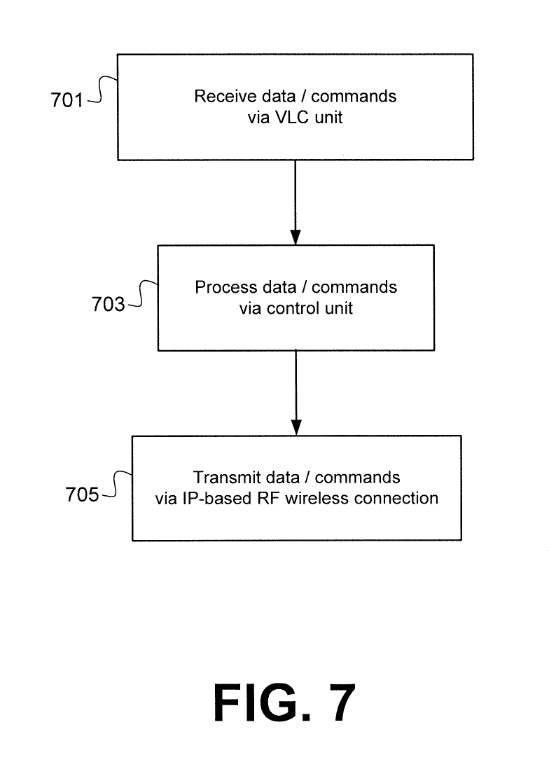

FIG. 7 illustrates a process by which communications including data and/or commands received by the smart LED device via the VLC unit of the smart LED device (stage 701) are processed by the control unit (stage 703) and transmitted to other smart LED devices and/or networked devices via the IP-based RF wireless unit of the smart LED device (stage 705). Processing the data and/or commands via the control unit at stage 703 further includes determining the destination of the data and/or commands (e.g., whether a command is intended for execution by the VLC unit, the IP-based RF wireless unit, or for other devices), reformatting the data and/or commands as needed, and routing/transmitting the data and/or commands to the appropriate destination.

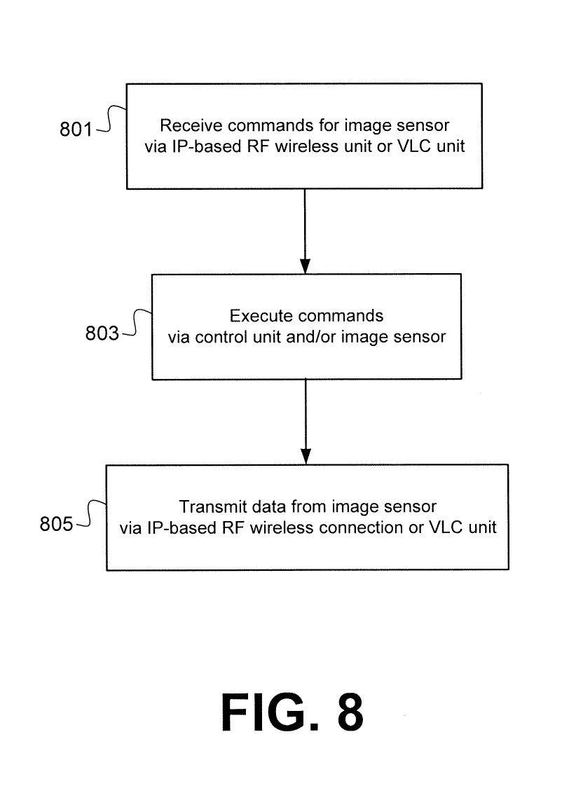

FIG. 8 illustrates a process for using the image sensor of a smart LED device, which includes receiving commands for the image sensor via the IP-based RF wireless unit of the smart LED device or the VLC unit of the smart LED device (stage 801), executing those commands via the control unit and/or image sensor (stage 803) to cause the image sensor to capture image or video information, and transmitting data from the image sensor to other smart LED devices and/or other networked device via the IP-based RF wireless unit of the smart LED device or the VLC unit of the smart LED device (stage 805). In an exemplary implementation, the commands sent to the image sensor to control and data received from the image sensor for transmission are routed through the control unit of the smart LED device (e.g., as depicted in FIGS. 5A and 5B).

Further, in exemplary embodiments of the invention, data communicated via the VLC unit and the IP-based RF wireless unit can include address information, position information, and/or identity information associated with various terminals. Smart LED devices as described above can thus be used in “location-aware” applications, such as indoor positioning and/or location-based broadcasting, where address, position, and/or identity information corresponding to terminals is exchanged.

It will be appreciated that, although the exemplary embodiments discussed above utilize IP-based RF wireless connectivity and VLC, the principles of the invention are not limited thereto. Other Non-Line-of-Sight (NLOS) and Line-of-Sight (LOS) access protocols may be integrated into network devices that are able to extend the coverage and functionality of each of the respective NLOS and LOS protocols used.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A communications device, comprising:
a light-emitting diode (LED) or LED array;
an internet protocol (IP)-based radiofrequency (RF) wireless unit, configured to transmit and receive data over a RF wireless communications network;
a visible light communication (VLC) unit, configured to drive the LED or LED array and modulate light generated by the LED or LED array with data; and
a control unit, connected to the IP-based RF wireless unit and the VLC unit, configured to facilitate communications between the VLC unit and IP-based RF wireless unit.

2. The communications device according to claim 1, wherein the IP-based RF wireless unit utilizes WiFi protocol.

3. The communications device according to claim 1, wherein the communications device is configured to broadcast address, position or identity information of the LED device using the LED or LED array.

4. The communications device according to claim 3, wherein the communications device is used for an indoor positioning or location-based broadcasting application.

5. The communications device according to claim 1, further comprising a non-volatile memory.

6. The communications device according to claim 1, further comprising:
an image sensor, configured to send the captured image or video signal to the control unit.

7. The communications device according to claim 1, wherein the communications device is configured to broadcast data via VLC using the VLC unit and LED or LED array.

8. The communications device according to claim 1, wherein the communications device is configured to transmit data via VLC using the VLC unit and LED or LED array.

9. The communications device according to claim 1, wherein the communications device is configured for bi-directional VLC using the VLC unit and LED or LED array.

10. The communications device according to claim 1, wherein the control unit comprises a microcontroller.

11. The communications device according to claim 1, wherein the control unit is further configured to utilize data received from the RF wireless communications unit to program or control the VLC unit.

12. The communications device according to claim 11, wherein the control unit is further configured to utilize the data received from the RF wireless communications unit to set an operating frequency for the VLC unit.

13. The communications device according to claim 11, wherein the control unit is further configured to utilize the data received from the RF wireless communications unit to set a light intensity for the VLC unit.

14. The communications device according to claim 1, wherein the VLC unit further comprises a LED driver and a VLC modulator.

15. The communications device according to claim 14, wherein the VLC unit further comprises a VLC receiver.

16. A communications device, comprising:
a first communications unit, configured to transmit and receive data over a Non-Line-Of-Sight (NLOS) communications network;
a second communications unit, configured to transmit data over a Line-Of-Sight (LOS) wireless communications network; and
a control unit, connected to the first and second communications units, configured to facilitate communications between the first and second communications units, and further configured to utilize data received from the NLOS communications network to program or control the second communications unit.

17. The communications device of claim 16, wherein the first communications unit is an internet protocol (IP)-based radiofrequency (RF) wireless unit, configured to transmit and receive data over an RF wireless communications network; and the second communications unit is a visible light communication (VLC) unit, configured to drive a light-emitting diode (LED) or LED array and modulate light generated by the LED or LED array with data;

18. A method for operating a communications device comprising a control unit, an internet protocol (IP)-based radiofrequency (RF) wireless unit and a visible light communication (VLC) unit, the method comprising:
receiving, by the IP-based RF wireless unit of the communications device, data from a RF wireless communications network;
processing, by the control unit of the communications device, the received data to control operation of the VLC unit of the communications device; and
performing, by the VLC unit of the communications device, VLC transmission based on the received data.

19. The method of claim 18, further comprising:
obtaining, by an image sensor corresponding to the communications device, image data; and
transmitting, by the communications device, the image data via the IP-based RF wireless unit or the VLC unit of the communications device.

20. The method according to claim 18, wherein the VLC transmission is performed via a light-emitting diode (LED) or LED array of the communications device, with the LED or LED array being used to provide illumination or a display.
